(19) United States
(12) Patent Application Publication
(10) Pub. No.: US 2020/0010757 A1
(43) Pub. Date: Jan. 9, 2020

(54) FORMULATION TO INCREASE OIL RECOVERY

(71) Applicant: Baker Hughes, a GE company, LLC, Houston, TX (US)

(72) Inventors: Lirio Quintero, Houston, TX (US); Heesong KOH, Stafford, TX (US)

(73) Assignee: Baker Hughes, a GE company, LLC, Houston, TX (US)

(21) Appl. No.: 16/459,885

(22) Filed: Jul. 2, 2019

Related U.S. Application Data
(60) Provisional application No. 62/694,230, filed on Jul. 5, 2018.

(51) Int. Cl. C09K 8/588; C09K 8/584; E21B 43/20

(52) U.S. Cl. CPC C09K 8/588; E21B 43/20; C09K 8/584

(57) ABSTRACT

An extended alkoxylated sulfate surfactant or alkyl propoxylated sulfate surfactant is used in combination with a secondary surfactant (co-surfactant) in a formulation to increase the oil recovery from crude oil reservoirs, the formulation being an appropriate combination of the extended alkoxylated sulfate surfactant or alkyl propoxylated sulfate surfactant with the secondary surfactant in a formulation of alkali-surfactant-polymer (ASP).

### CROSS-REFERENCE TO RELATED APPLICATION

This application claims the benefit of U.S. Provisional Application Ser. No. 62/694,230 filed Jul. 5, 2018, incorporated herein by reference in its entirety.

### TECHNICAL FIELD

The present invention relates to methods and compositions to increase the recovery of crude oil from subterranean formations, and in a more particular non-limiting embodiment, relates to alkali-surfactant-polymer (ASP) formulations suitable for use in enhanced oil recovery (EOR) methods using the ASP formulations.

### BACKGROUND

In the exploration and production of hydrocarbons from subterranean formations, injection fluids may be used in enhanced oil recovery (EOR) operations, which are sophisticated procedures that use viscous forces and/or interfacial forces to increase the production of hydrocarbon, e.g. crude oil, from subterranean oil reservoirs. The EOR procedures may be initiated at any time after the primary or secondary productive life of an oil reservoir when the oil production begins to decline. The efficiency of EOR operations may depend on reservoir temperature, pressure, depth, net pay, permeability, porosity, residual oil and water saturations, fluid properties, such as oil viscosity, total acid number (TAN) and oil composition, and the like.

EOR operations are considered a tertiary method of hydrocarbon recovery and may be necessary when the primary and/or secondary recovery operation has left behind a substantial quantity of hydrocarbons in the subterranean formation. Primary methods of oil recovery use the natural energy of the reservoir to produce oil or gas and do not require external fluids or heat as a driving energy; EOR methods are used to inject materials into the reservoir that are not normally present in the reservoir.

Secondary EOR methods of oil recovery inject external fluids into the reservoir, such as water and/or gas, to re-pressurize the reservoir and increase the oil displacement. Tertiary EOR methods include the injection of special fluids, such as chemicals, miscible gases and/or thermal energy. The EOR operations follow the primary or secondary operations and target the interplay of capillary and viscous forces within the reservoir. For example, in EOR operations, the energy for producing the remaining hydrocarbons from the subterranean formation may be supplied by the injection of fluids into the formation under pressure through one or more injection wells penetrating the formation, whereby the injection fluids drive the hydrocarbons to one or more nearby producing wells penetrating the formation. EOR operations are typically performed by injecting the fluid through the injection well into the subterranean reservoir to restore formation pressure, improve oil displacement or fluid flow in the reservoir, and the like.

Examples of EOR operations include water-based flooding and gas injection methods. Water-based flooding may also be termed “chemical flooding” if chemicals are added to the water-based injection fluid. Water-based flooding includes, but is not necessarily limited to, polymer flooding, ASP (alkali/surfactant/polymer) flooding, SP (surfactant/polymer) flooding, low salinity water and microbial EOR. Gas injection includes, but is not necessarily limited to, immiscible and miscible gas methods, such as carbon dioxide flooding, and the like.

It would be desirable if additives were developed for fluid compositions used during EOR to improve the mobilization of oil during its recovery by increasing oil solubilization and reducing interfacial tension (IFT).

### SUMMARY

There is provided, in one non-restrictive embodiment, a method for treating a subterranean crude oil-bearing formation to recover crude oil therefrom, where the method includes injecting an alkali-surfactant-polymer (ASP) formulation into the subterranean crude oil-bearing formation. The ASP formulation in turn includes a primary surfactant that is an extended alkoxylated sulfate surfactant and/or an alkyl propoxylated sulfate; a secondary surfactant, different from the primary surfactant, which secondary surfactant may be an alkyl benzene sulfonate (ABS), internal olefin sulfonate (IOS), alkyl polyglucoside (APG), and/or alkyl propoxylated carboxylates or combinations of these surfactants; an alkali, e.g. sodium carbonate (soda ash); and polymer, in non-limiting example, a hydrolyzed polyacrylamide (HPAM). The method additionally includes contacting the crude oil with the ASP formulation.

There is also provided, in a non-limiting form, an ASP formulation per se, such as that described immediately above.

### BRIEF DESCRIPTION OF THE DRAWING

FIG. 1 is a photograph of an alkali scan of Formulation #1 from Table 1 illustrating the Winsor phases for various weight percentages of Formulation #1 showing that Winsor III was achieved at 1.75 wt % of alkali (Na₂CO₃) concentration, and

FIG. 2 is a photograph of a brine salinity scan of Formulation #2 from Table 1 illustrating the Winsor phases for various weight percentages of Formulation #2 showing that Winsor III was achieved in the range of 1.2 to 1.5 wt % of alkali (Na₂CO₃) concentration.

### DETAILED DESCRIPTION

It has been discovered that an extended alkoxylated sulfate surfactant and/or an alkyl propoxylated sulfate (primary surfactant) in combination with a secondary surfactant (also called a co-surfactant herein) may be used together in a formulation to increase the oil recovery from crude oil reservoirs. The new discovery is the appropriate combination of the primary surfactant with a secondary surfactant in a formulation of an alkali-surfactant-polymer (ASP). The extended alkoxylate sulfate surfactant may be synthesized using one or more branched alcohol having 10 to 32 carbons atoms (e.g. Guerbet alcohols having 10 to 32 carbons), propylene oxide (PO) and/or ethylene oxide (EO) followed by a sulfation process. A second option for the primary surfactant is a propoxylated sulfate surfactant (e.g. C₁₀₋₁₆-(PO)₁₃-sulfate). The secondary surfactants are selected from sulfonate surfactants and or polyglucoside surfactants. The described synthetic surfactants are used in combination with (1) an alkali, such as soda ash, to generate natural surfactants and to reduce consumption and adsorption of the synthetic surfactants; and (2) polymers such as hydrolyzed polyacrylamide (HPAM) biopolymers, associative polymers, copolymers and/or terpolymers to increase the viscosity of the fluid. One non-limiting example of a suitable biopolymer is schleroglucan. Associative polymers are defined herein as hydrophobically-modified or associative water-soluble copolymers (HMWSPs). Suitable copolymers include, but are not necessarily limited to, acrylamide/acrylic acid (AMD/AA), acrylamide/acrylamide tertiary butyl sulfonic acid/acrylic acid (AMD/ATBS), and combinations thereof. Suitable terpolymers include, but are not necessarily limited to, acrylamide/acrylamide tertiary butyl sulfonic acid/acrylic acid (AMD/ATBS/AA). Addition of one or more co-solvent is optional to improve the performance of the ASP formulation. The described ASP blend aims to be used for mobilization of oil by increasing oil solubilization and reducing interfacial tension (IFT) between the crude oil and the water in reservoir conditions for enhanced oil recovery applications.

In more detail, an ASP formulation that produces maximum oil solubilization or near-zero free energy in a crude oil-surfactant-water system is selected based on the properties of the crude oil and the production water, and the injection water used and the temperature of the operation. The required hydrophilic-lipophilic affinity is obtained with the blend of either an alkyl propoxylated sulfate or extended sulfate (primary surfactant), one or more secondary surfactants, and optional solvent allowing a better packing of the molecules at the interface, which results in a higher solubilization of the crude oil.

The choices of the blend components and proportions are primarily based upon the affinity of the surfactants with respect to a particular crude oil, characterized by the equivalent alkane carbon number (EACN) and composition. The selection of the length of carbon chain and alkoxylate PO/EO number adjustment by alkoxylation that have different affinities for oil and water can be determined by a formulation scan study of surfactant blend/water/oil phase behavior. A particular non-limiting example is the development of an ASP formulation for a very paraffinic crude oil with low or high API degree (up to 40 API degree). The optimum ASP formulation has an extended alkoxylate sulfate surfactant with C24 Guerbet alcohol, propoxylated oxide of around 35 units and ethylene oxide of around 10 units blended with secondary surfactants from the alkyl aryl sulfonate surfactant family (e.g. C12-20 alkyl benzene sulfonate and C8-13 alkyl benzene sulfonate). A second, non-restrictive optimum formulation has an alkoxylate surfactant and/or alkyl aryl sulfonate combined with an alkyl polyglucoside. An example of the second, non-restrictive optimum formulation has an alkyl propoxylated sulfate with around 7 to 10 propoxylated oxide units with a secondary surfactant (alkyl polyglucoside with a range of C8-C16 alkyl chain. The alkali and polymer used in this ASP formulation may be soda ash and hydrolyzed polyacrylamide. Thus, also described herein is a method for designing or customizing the ASP formulation to have a particular solubilization ratio between a particular crude oil, and the combination of the production water and/or the injection water and the temperature.

One non-limiting process for selection of surfactants for ASP flooding includes the following steps:
Selection of the best surfactant formulations for ASP flood requires systematic studies of phase behavior of the crude oil/water/surfactants systems. The objective of the phase behavior studies for ASP flooding is to select surfactant formulations that produce high solubilization of crude oil and water at the reservoir conditions (temperature and water/alkali composition to be injected in the reservoir). A formulation with high solubilization ratio between oil and water will have ultra-low interfacial tension. A solubilization ratio higher than 5 at oil/water ratio systems of 90/10 is desired at surfactant concentration as low as 0.3% (wt/wt). As the oil/water ratio increases the solubilization ratio increases. Notice that oil solubilization also increases with the surfactant concentration.
The phase behavior studies start with the characterization of the crude oil, injection water and production water samples. The equivalent alkane number (EACN) of the crude oil is measured. The data of the fluid characterization and the EACN enable the identification of surfactants that could potentially perform well for the specific crude oil, water salinity and temperature.
The phase behavior of water-surfactant-oil systems is studied by preparing a series of vials in which only one variable is progressively changed (e.g. alkali concentration).
The next step is to prepare the vials for phase behavior studies using crude oil, injection water and various surfactant blends and systematically varying either the alkali concentration, the ratio between surfactants, or the proportion of oil/water ratio.
A progression from two-phase (Winsor I) to three-phase (Winsor III) to two-phase (Winsor II) is observed when a variable changes. The volume of oil and water that is solubilized in the Winsor III system is measured and used to calculate the solubilization ratio as function of the alkali concentration.
Based on the series of the phase behavior scans, the surfactant combination and the alkali concentration for the ASP formulation is selected.
The polymer is selected based on the water salinity and reservoir temperature. HPAM are the most common polymers for ASP applications, but other molecules, such as copolymers, are used for high temperatures (>75C).

A brief explanation of Winsor phase behavior is in order. Microemulsions are thermodynamically stable, macroscopically homogeneous mixtures of at least three components: a polar phase and a nonpolar phase, and at least one surfactant. Microemulsions form spontaneously and differ markedly from the thermodynamically unstable macroemulsions, which depend upon intense mixing energy for their formation. Microemulsions are well known in the art, and attention is respectfully directed to S. Ezrahi, A. Aserin and N. Garti, “Chapter 7: Aggregation Behavior in One-Phase (Winsor IV) Microemulsion Systems”, in P. Kumar and K. L. Mittal, ed., Handbook of Microemulsion Science and Technology, Marcel Dekker, Inc., New York, 1999, pp. 185-246.

The referenced chapters describe the types of microemulsion phase behavior defined by Winsor: Winsor I, Winsor II and Winsor III. A system or formulation is defined as: Winsor I when it contains a microemulsion in equilibrium with an excess oil phase; Winsor II when it contains a microemulsion in equilibrium with excess water; and Winsor III when it contains a middle phase microemulsion in equilibrium with excess water and excess oil.

Turning back to surfactants suitable in the methods and compositions described herein, the primary surfactant includes, but is not necessarily limited to extended alkoxylated sulfate surfactants, alcohol propoxylated sulfates, alkyl phenol propoxylated sulfates, and combinations thereof. The extended alkoxylated sulfate surfactants may be synthesized using branched alcohols having 12-32 carbon atoms (e.g. Guerbet alcohols) reacted with propylene oxide (PO) and/or ethylene oxide (EO) followed by a sulfation process. A suitable number of PO (propoxy) units ranges from about 20 independently to about 50; alternatively from about 35 independently to about 45. As used herein with respect to a range, “independently” means that any threshold may be used together with another threshold to give a suitable alternative range. In the case where primary surfactant is ethoxylated, the number of EO (ethoxy) units may range from about 3 independently to about 20; alternatively from about 8 independently to about 15. The EO groups and PO groups may be added in blocks, mixed, or randomly.

The secondary surfactants are different from the primary surfactant and may include, but is not necessarily limited to, alkyl benzene sulfonates (ABS), internal olefin sulfonates (105), alkyl polyglucosides and/or alkyl propoxylated carboxylates, where the alkyl group may be linear or branched of 10 to 30 carbon atoms, and where the number of PO units ranges from 3 independently to 50, alternatively from 7 independently to 45.

The alkali forms natural surfactants by a saponification reaction of certain components present in the crude oil such as macromolecules that contain carboxylate groups. Suitable alkali components include, but are not necessarily limited to, sodium hydroxide (NaOH), potassium hydroxide (KOH), sodium carbonate (soda ash), amines such as, but not necessarily limited to, monoethanolamine, and combinations thereof. Sodium carbonate is one particularly suitable alkali.

A polymer is also used in the ASP herein, as described in more detail previously. A particularly suitable polymer is partially hydrolyzed or fully or completely hydrolyzed polyacrylamide (HPAM). The HPAM may have a molecular weight range of from 2 independently to 22 million Dalton.

Optional co-solvents include, but are not necessarily limited to, alcohols including but not necessarily limited to methanol, isopropyl alcohol, butanol, pentanol, hexanol, isooctyl alcohol, and the like; glycol ethers including but not necessarily limited to ethylene glycol mono-butyl ether, dipropylene glycol mono-methyl ether, propylene glycol ethers and the like; alcohols substituted with less than six EO units; phenols substituted with less than 6 EO units; and glycol ethers substituted with less than 6 EO units.

The optional co-surfactants, different from the primary surfactant and the secondary surfactant, include internal olefin sulfonates and surfactants from the group of alcohol ethoxylates, carboxylates, PO-EO carboxylates, EO carboxylate, PO carboxylate, polyglucosides, polyglucoside carboxylate, and combinations of these.

In one non-limiting embodiment the ASP may have the following proportions of components:
from about 0.05 independently to about 0.35 wt %; alternatively from about 0.05 wt % independently to about 0.25 wt %, of the primary surfactant;
from about 0.01 independently to about 0.2 wt %, alternatively from about 0.025 independently to about 0.15 wt %, of the secondary surfactant;
from about 0.5 independently to about 4 wt %; alternatively from about 1 independently to about 3 wt %, of the alkali;
from about 0.05 independently to about 0.35 wt %; alternatively from about 0.1 independently to about 0.25 wt %, of the HPAM;
from about 0.01 independently to about 0.3 wt %; alternatively from about 0.01 independently to about 0.05 wt %, of the optional co-solvent; and
the balance being water;
   based on the total ASP formulation.

One suitable, non-limiting sequence for combining the alkali and the surfactant is the addition of alkali to the water followed by the surfactants. The polymer is then added to the solution of alkali-surfactant(s). One non-limiting example of the procedure is the addition of (1) alkali and (2) surfactant and (3) polymer to the injection water to form an ASP formulation.

In one non-limiting embodiment the ASP formulation is injected into subterranean crude oil-bearing formation. The ASP formulation contacts the crude oil, increasing its oil solubilization and reducing the IFT between the crude oil and the water with the ASP in the reservoir conditions, improving enhanced oil recovery. That is, the method also includes at least partially removing the crude oil from the subterranean crude oil-bearing formation. It is not necessary for all of the crude oil to be removed from the formation for the method to be considered successful. The enhanced oil recovery is greater than an otherwise identical method absent the ASP formulation. In another non-restrictive version, the temperature of the EOR process ranges from about 40° C. independently to about 100° C.; alternatively from about 50° C. independently to about 75° C.

The ASP formulation may be evaluated by conducting a formulation scan. A formulation scan or study of surfactant blend/water/oil phase behavior is performed by changing one variable at the time. For example in an alkali scan, a series of vials are prepared with a particular system (surfactant/brine/oil) and only the alkali concentration is changed in each vial. The objective of the formulation scan is to determine the optimum formulation by the characteristic progression from two-phase (Winsor I) to three-phase (Winsor III) to two-phase (Winsor II) when a variable changes. Winsor III is the target formulation for EOR purposes. This corresponds to the zone of minimum interfacial tension and maximum solubilization of crude oil and water.

In one non-limiting embodiment, the method and composition described herein may be a subterranean hydrocarbon reservoir with a particular crude oil type treated or contacted by the ASP formulations described herein. The crude oil may, in one non-limiting version, be a very paraffinic crude oil and/or one having high molecular weight wax. By “very paraffinic” is meant that the crude oil has between 1 independently to about 40 wt % n-paraffins, alternatively from about 10 independently to about 25 wt % n-paraffins, where the n-paraffins have 20 or more carbon atoms.

The invention will be further described with respect to the following Examples, which are not meant to limit the invention, but rather to further illustrate the various embodiments.

### EXAMPLES

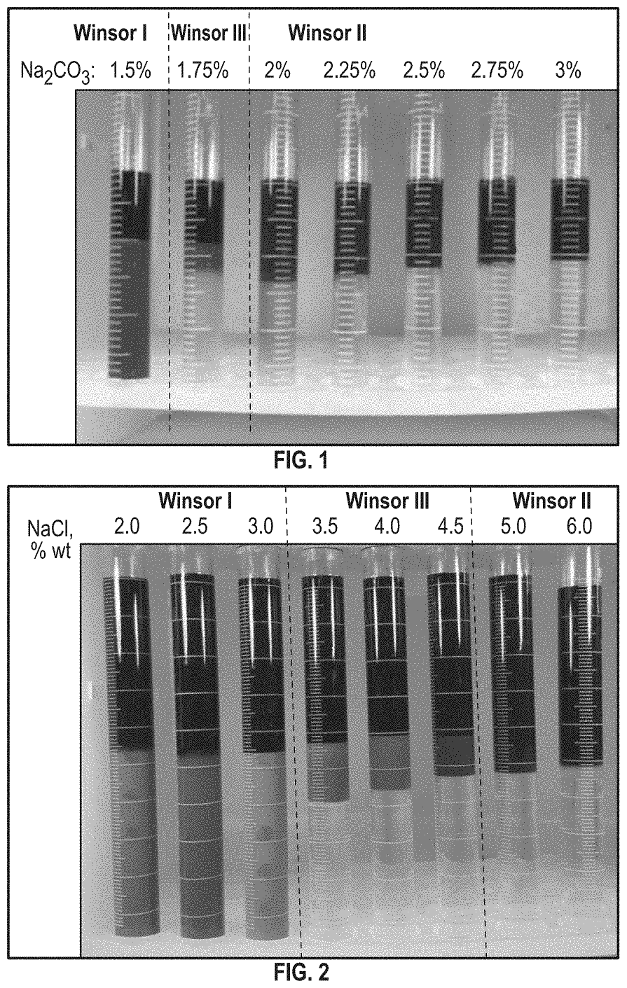

Table 1 presents two ASP formulations as described herein that can be used in field applications. FIG. 1 is a photograph of alkali scan of Formulation #1. FIG. 2 is a brine salinity scan of Formulation #2 from Table 1, respectively, illustrating the Winsor phases for various weight percentages of Formulation #1 showing that Winsor III was achieved at 1.75 wt % of alkali concentration.

TABLE 1
ASP Formulations for Field Application

| Components | Formulation #1 | Formulation #2 |
|---|---|---|
| Surfactant 1 | C28 alcohol-35 (PO) | Alkyl propoxylate (PO) sulfate |
| | 10 (EO) sulfate | with C13 alkyl chain and 13 PO |
| Surfactant 2 | Alkyl benzene sulfonate | Alkyl polyglucoside with C8 to |
| | with C12-C17 alkyl chain | C16 alkyl chain |
| Alkali | Soda ash | — |
| Hydrolyzed | Commercially available | Commercially available HPAM |
| polyacrylamide | HPAM | |
| polymer | | |

In the foregoing specification, the invention has been described with reference to specific embodiments thereof, and has been described as effective in providing formulation methods, ASP formulations, and EOR methods of using the ASP formulations for improving oil recovery from a subterranean reservoir during EOR operations. However, it will be evident that various modifications and changes can be made thereto without departing from the broader scope of the invention as set forth in the appended claims. Accordingly, the specification is to be regarded in an illustrative rather than a restrictive sense. For example, specific ASP formulations, primary surfactants, secondary surfactants, alkalis, polymers, optional co-solvents, optional co-surfactants, other additional components, component proportions, and the like falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, there may be provided a method for treating a subterranean crude oil-bearing formation to recover crude oil therefrom, where the method comprises, consists essentially of, or consists of a primary surfactant selected from the group consisting of extended alkoxylated sulfate surfactants, alkyl propoxylated sulfates, and combinations thereof; a secondary surfactant, different from the primary surfactant, selected from the group consisting of alkyl benzene sulfonates (ABS), internal olefin sulfonate (IOS), alkyl polyglucosides, alkyl propoxylated carboxylates, and combinations thereof; an alkali selected from the group consisting of sodium carbonate, sodium hydroxide, potassium hydroxide, amines, and combinations thereof; and a polymer (e.g. a partially or fully hydrolyzed polyacrylamide (HPAM)); where the method further comprises, consists essentially of, or consists of contacting the crude oil with the formulation.

The alkali-surfactant-polymer (ASP) formulation itself may consist of or consist essentially of a primary surfactant selected from the group consisting of extended alkoxylated sulfate surfactants, alkyl propoxylated sulfates, and combinations thereof; a secondary surfactant, different from the primary surfactant, selected from the group consisting of alkyl benzene sulfonates (ABS), internal olefin sulfonate (IOS), alkyl polyglucosides, alkyl propoxylated carboxylates, and combinations thereof; an alkali selected from the group consisting of sodium carbonate, sodium hydroxide, potassium hydroxide, amines, and combinations thereof; and a polymer, a non-limiting example of which is hydrolyzed polyacrylamide (HPAM).

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for treating a subterranean crude oil-bearing formation to recover crude oil therefrom, the method comprising:
injecting an alkali-surfactant-polymer (ASP) formulation into the subterranean crude oil-bearing formation where the formulation comprises:
a primary surfactant selected from the group consisting of extended alkoxylated sulfate surfactants, alkyl propoxylated sulfates, and combinations thereof;
a secondary surfactant, different from the primary surfactant, selected from the group consisting of alkyl benzene sulfonates (ABS), internal olefin sulfonates (105), alkyl polyglucosides, alkyl propoxylated carboxylates, and combinations thereof;
an alkali selected from the group consisting of sodium carbonate, sodium hydroxide, potassium hydroxide, amines, and combinations thereof; and
a polymer; and
contacting the crude oil with the ASP formulation.

2. The method of claim 1 where:
the subterranean crude oil-bearing formation further comprises production water; and
the method further comprises designing the ASP formulation to have a solubilization ratio between the crude oil, and the combination of the production water, and/or injection water of the method, and temperature of the method.

3. The method of claim 2 further comprising mobilizing the crude oil by increasing oil solubilization and reducing interfacial tension (IFT) between the crude oil and the production water at the temperature.

4. The method of claim 3 further comprising at least partially removing the crude oil from the subterranean crude oil-bearing formation.

5. The method of claim 2 where the temperature ranges from about 40 to about 100° C.

6. The method of claim 1 where the primary surfactant is selected from the group consisting of
extended alkoxylated sulfate surfactants alkoxylated with at least one alkoxy unit selected from the group consisting of:
from 20 to 50 propoxy units,
from 3 to 20 ethoxy units, and
combinations thereof;
alkyl propoxylated sulfates comprising from 7 to 50 propoxy units, and combinations thereof.

7. The method of claim 1 where the ASP formulation comprises
about 0.05 to about 0.35 wt % of the primary surfactant;
about 0.01 to about 0.2 wt % of the secondary surfactant;
about 0.5 to about 4 wt % of the alkali;
about 0.05 to about 0.35 wt % of the HPAM; and
the balance being water;
based on the total ASP formulation.

8. The method of claim 1 where the ASP formulation additionally comprises:
a co-solvent selected from the group consisting of alcohols, glycol ethers, alkoxylated phenols, and combinations thereof.

9. The method of claim 8 where the ASP formulation comprises about 0.01 to about 0.3 wt % of the co-solvent.

10. The method of claim 1 where the polymer is selected from the group consisting of hydrolyzed polyacrylamide (HPAM), schleroglucan, hydrophobically-modified or associative water-soluble copolymers (HMWSPs), acrylamide/acrylic acid (AMD/AA) copolymer, acrylamide/acrylamide tertiary butyl sulfonic acid/acrylic acid (AMD/ATBS) copolymer, acrylamide/acrylamide tertiary butyl sulfonic acid/acrylic acid (AMD/ATBS/AA) terpolymer, and combinations thereof.

11. A method for treating a subterranean crude oil-bearing formation to recover crude oil therefrom, the method comprising:
injecting an alkali-surfactant-polymer (ASP) formulation into the subterranean crude oil-bearing formation where the formulation comprises:
about 0.05 to about 0.35 wt % of a primary surfactant selected from the group consisting of:
extended alkoxylated sulfate surfactants alkoxylated with at least one alkoxy unit selected from the group consisting of:
from 20 to 50 propoxy units,
from 3 to 20 ethoxy units, and
combinations thereof;
alkyl propoxylated sulfates comprising from 7 to 50 propoxy units, and
combinations thereof;
about 0.01 to about 0.2 wt % of a secondary surfactant, different from the primary surfactant, selected from the group consisting of alkyl benzene sulfonates (ABS), internal olefin sulfonates (IOS), alkyl polyglucosides, alkyl propoxylated carboxylates, and combinations thereof;
about 0.5 to about 4 wt % of an alkali selected from the group consisting of sodium carbonate, sodium hydroxide, potassium hydroxide, amines, and combinations thereof; and
about 0.05 to about 0.35 wt % of a hydrolyzed polyacrylamide (HPAM); and
the balance being water, based on the total ASP formulation; and
contacting the crude oil with the ASP formulation.

12. The method of claim 11 where:
the subterranean crude oil-bearing formation further comprises production water; and
the method further comprises designing the ASP formulation to have a solubilization ratio for the crude oil, the production water, injection water of the method, and temperature of the method.

13. The method of claim 12 further comprising:
mobilizing the crude oil by increasing oil solubilization and reducing interfacial tension (IFT) between the crude oil and the water at the temperature, where the water is selected from the group consisting of the production water, the injection water, and combinations thereof; and
at least partially removing the crude oil from the subterranean crude oil-bearing formation.

14. The method of claim 12 where the temperature ranges from about 40 to about 100° C.

15. The method of claim 11 where the ASP formulation additionally comprises:
about 0.01 to about 0.3 wt % of a co-solvent selected from the group consisting of alcohols, glycol ethers, alkoxylated phenols, and combinations thereof.

16. An alkali-surfactant-polymer (ASP) formulation comprising:
a primary surfactant selected from the group consisting of extended alkoxylated sulfate surfactants, alkyl propoxylated sulfates, and combinations thereof;
a secondary surfactant, different from the primary surfactant, selected from the group consisting of alkyl benzene sulfonates (ABS), internal olefin sulfonates (105), alkyl polyglucosides, alkyl propoxylated carboxylates, and combinations thereof,
an alkali selected from the group consisting of sodium carbonate, sodium hydroxide, potassium hydroxide, amines, and combinations thereof; and
a polymer.

17. The ASP formulation of claim 16 where the primary surfactant is selected from the group consisting of:
extended alkoxylated sulfate surfactants alkoxylated with at least one alkoxy unit selected from the group consisting of:
from 20 to 50 propoxy units,
from 3 to 20 ethoxy units, and
combinations thereof;
alkyl phenol propoxylated sulfates comprising from 7 to 50 propoxy units, and
combinations thereof.

18. The ASP formulation of claim 16 further comprising:
about 0.05 to about 0.35 wt % of the primary surfactant;
about 0.01 to about 0.2 wt % of the secondary surfactant;
about 0.5 to about 4 wt % of the alkali;
about 0.05 to about 0.35 wt % of the HPAM; and
the balance being water;
based on the total ASP formulation.

19. The ASP formulation of claim 16 additionally comprising:
a co-solvent selected from the group consisting of alcohols, glycol ethers, alkoxylated phenols, and combinations thereof.

20. The ASP formulation of claim 15 further comprising about 0.01 to about 0.3 wt % of the co-solvent.
